(19) United States
(12) Patent Application Publication
(10) Pub. No.: US 2021/0114016 A1
(43) Pub. Date: Apr. 22, 2021

(54) POLYMER SUBSTITUTES FOR GLASS PRODUCTS AND MATERIALS USED FOR ANALYSIS OF LIQUID SAMPLES

(71) Applicant: Centech Corp., Inglewood, CA (US)

(72) Inventor: Omar Bennabi Kunbargi, Los Angeles, CA (US)

(73) Assignee: Centech Corp., Inglewood, CA (US)

(21) Appl. No.: 17/133,566

(22) Filed: Dec. 23, 2020

Related U.S. Application Data
(63) Continuation-in-part of application No. 16/129,769, filed on Sep. 12, 2018.
Application No. 16/129,769 is a continuation-in-part of application No. PCT/US2018/021222, filed on Mar. 6, 2018.
(60) Provisional application No. 62/573,207, filed on Oct. 17, 2017.
(60) Provisional application No. 62/503,401, filed on May 9, 2017.
(60) Provisional application No. 62/467,320, filed on Mar. 6, 2017.

(51) Int. Cl. B01L 3/00; C08L 81/06

(52) U.S. Cl. CPC B01L 3/5021; C08L 81/06; C08L 2201/08; B01L 2400/0409; C08L 2201/10; B01L 2300/0832; C08L 2203/10

(57) ABSTRACT

The use of polymeric materials as glass substitutes to make products suitable for use in the analysis of liquid samples and the corresponding products are disclosed herein. Polymer-based products suitable for use to analyze liquid samples may be particularly useful in petroleum industry applications. Specifically, a sample-testing apparatus, such as a centrifuge tube or hydrometer, for use with a sample containing materials such as crude oil, petroleum products, petrochemicals, fractions thereof, and impurities therein is disclosed herein. A sample-testing apparatus comprising one or more polymers in the polysulfone family, preferably polysulfone (PSU) and polyphenylsulfone (PPSU), and most preferably polyphenylsulfone may render the apparatus substantially transparent; substantially chemically inert to degradation by crude oil and petroleum products; substantially thermally stable; substantially rigid when subjected to conditions such as elevated temperatures, externally-applied threes, or the combination thereof; and substantially shatter-resistant and will provide superior performance compared to products currently used in industry.

### CROSS-REFERENCE TO RELATED APPLICATIONS

This application is a continuation-in-part of U.S. patent application Ser. No. 16/129,769, filed on Sep. 12, 2018, which is a continuation-in-part of PCT Patent Application No. PCT/US2018/021222, filed on Mar. 6, 2018, which claims the benefit of and priority to U.S. Provisional Patent Application Ser. Nos. 62/467,320, filed on Mar. 6, 2017, 62/503,401, filed on May 9, 2017, and 62/573,207, filed on Oct. 17, 2017, the disclosures of which are incorporated herein in their entireties by reference.

### BACKGROUND

### Field of the Invention

The present disclosure relates to the use of polymers as substitutes for glass in products suitable for use in sample analysis for applications in industries that involve the processing of fluids, such as the petroleum, chemical, food, beverage, and other similar industries.

### Description of the Related Art

Many applications require the analysis of liquid samples using a variety of products, instruments, and methods of analysis. Such applications are prevalent in industries such as the petroleum, chemical, food, and beverage industries.

In the petroleum industry, it is often necessary to test samples to obtain quality or purity measurements. Containers and instrumentation used to test samples include centrifuge tubes, hydrometers, oil thieves, and various other products and instrumentation. The American Petroleum Institute requires certain applications use glass containers and instrumentation for measuring various properties. See, e.g., American Petroleum Institute, Manual of Petroleum Measurement Standards, ch. 10, section 4, p. 13 (centrifuge tubes used to measure sediment and water in crude oil samples should be made of annealed glass); American Petroleum Institute, Manual of Petroleum Measurement Standards, ch. 9, section 1, p. 2 (hydrometers must be made of glass). Since glass products are susceptible to breakage or shattering during handling and use, efforts have been made to increase the strength and stability of the glass used in petroleum industry applications where glass is required.

A centrifuge is an apparatus that causes an object to rotate around a fixed axis, thereby applying a force perpendicular to the axis of spin. When the centrifuge operates, more dense particles and substances move radially outward on account of centripetal acceleration, and less dense particles and substances move radially inward. In a centrifuge that employs one or more sample tubes, radial acceleration causes denser particles to settle to the bottom of a given sample tube while lower density substances rise to the top of said sample tube.

In the petroleum industry, centrifuges are used for multiple applications, including or use to measure sediment and water in crude oil and petroleum products. Centrifuge tubes for these applications are almost invariably made from glass. Since glass products are highly susceptible to breakage or shattering during handling and centrifugation, substantial efforts have been made to increase the shatter-resistance of the glass used to make the centrifuge tubes. These efforts have been focused primarily on increasing the strength and stability of the glass centrifuge tubes, which has led to a steady increase in the wall thickness of glass centrifuge tubes designed for petroleum industry applications. The use of thick-walled glass centrifuge tubes introduces a myriad of other potential problems, such as increased weight and cost of each centrifuge tube and other problems. Moreover, thick-walled glass centrifuge tubes are still susceptible to breakage, and thus while somewhat shatter-resistant, are certainly not shatterproof.

A hydrometer is an instrument used for measuring the relative density of liquids using principles of buoyancy. A hydrometer is typically calibrated and graduated according to a desired scale, such as specific gravity or API gravity. A hydrometer uses Archimedes' principle, namely that a solid suspended in a fluid is buoyed by a force equal to the weight of the fluid displaced by the submerged part of the suspended solid, to determine the relative density of a liquid compared to a desired scale. In the petroleum industry, hydrometers are used to determine how heavy or light petroleum liquids are.

Hydrometers used in the petroleum industry are invariably made from glass. Since glass products are highly susceptible to breakage or shattering during handling and use, increasing the shatter-resistance of the glass used to make hydrometers by increasing the strength and stability of the glass is a focus for new product development. As for centrifuge tubes, increasing the strength and stability glass hydrometers generally correlates with increasing glass thickness. This leads to similar problems as those encountered with the use of thick-walled glass centrifuge tubes. In addition, like thick-walled glass centrifuge tubes, glass hydrometers with increased strength and stability are still susceptible to breakage, and thus while somewhat shatter-resistant, are certainly not shatterproof.

Thus, there is a great need in the petroleum industry for centrifuge tubes, hydrometers, and other instrumentation that overcome the challenges associated with the development, manufacture, and use of shatter-resistant glass products and instrumentation for various applications.

### SUMMARY

The use of polymeric materials as glass substitutes to make products suitable for use in the analysis of liquid samples and the corresponding products are disclosed herein. Polymer-based products suitable for use in the analysis of liquid samples may be particularly useful in petroleum industry applications, though the use of such products is not limited to the petroleum industry. It has been found that making products from one or more polymers selected from the group consisting of polymers in the polysulfone family, more preferably selected from the group consisting of polysulfone (PSU) and polyphenylsulfone (PPSU), and most preferably polyphenylsulfone may render the products substantially transparent; substantially chemically inert to degradation by crude oil and petroleum products; substantially thermally stable; substantially rigid when subjected to conditions such as elevated temperatures, externally-applied forces, or the combination thereof; and substantially shatter-resistant and will result in products with superior performance as compared to products currently used in industrial applications.

In one embodiment, a container suitable for obtaining information from a sample containing materials such as, but not limited to, crude oil, petroleum products, petrochemicals, fractions thereof, and impurities therein is described. The container preferably comprises a tube and more preferably a centrifuge tube. It has been found that a centrifuge tube comprising one or more polymers that render the centrifuge tube substantially transparent, substantially chemically inert to degradation by crude oil and petroleum products; substantially thermally stable; substantially rigid when subjected to conditions such as elevated temperatures, centrifugal forces, or the combination thereof; and substantially shatter-resistant provides superior performance for sediment and water measurement in crude oil and petroleum products compared to centrifuge tubes that do not satisfy one or more of these criteria. It has also been found that one or more polymers selected from the group consisting of polymers in the polysulfone family, more preferably selected from the group consisting of polysulfone (PSU) and polyphenylsulfone (PPSU), and most preferably polyphenylsulfone meet the unique criteria set forth above and result in an improved product compared to those currently used in industry.

Accordingly, a container useful for obtaining information from samples comprising one or more polymers is provided, wherein the container is substantially transparent; substantially chemically inert to degradation by crude oil and petroleum products; substantially thermally stable; substantially rigid when subjected to conditions such as elevated temperatures, centrifugal forces, or the combination thereof; and substantially shatter-resistant.

A method of obtaining information from a sample containing materials such as, but not limited to, crude oil, petroleum products, petrochemicals, fractions thereof, and impurities therein is also disclosed herein. The method comprises the steps of (1) introducing the sample into a container, (2) applying a force to the container to generate at least two layers within the container, and (3) obtaining information from at least one of the at least two layers, wherein the container is substantially transparent; substantially chemically inert to degradation by crude oil and petroleum products; substantially thermally stable; substantially rigid when subjected to conditions such as elevated temperatures, centrifugal forces, or the combination thereof; and substantially shatter-resistant.

A method of making the disclosed container is also disclosed herein. The method comprises: (1) heating at least one polymer selected from the group consisting of the polysulfone family, (2) extruding the heated polymer to generate an extruded polymer, (3) introducing the extruded polymer into a mold having the shape of the container, and (4) removing the mold from the extruded polymer contained within the mold to generate a polymer container, wherein the polymer container is substantially transparent; substantially chemically inert to degradation by crude oil and petroleum products; substantially thermally stable; substantially rigid when subjected to conditions such as elevated temperatures, centrifugal forces, or the combination thereof; and substantially shatter-resistant.

In another embodiment, a hydrometer suitable for obtaining information from a sample containing materials such as, but not limited to, crude oil, petroleum products, petrochemicals, fractions thereof, and impurities therein is described. A hydrometer comprising one or more polymers that render the hydrometer substantially chemically inert to degradation by crude oil and petroleum products and substantially shatter-resistant provides superior performance for measurement of API gravity or other measurements of relative density of a sample for crude oil and petroleum products compared to hydrometers that do not satisfy these criteria. In some preferred embodiments, the disclosed hydrometer is also substantially thermally stable and substantially rigid when subjected to conditions such as elevated temperatures. Hydrometers made from one or more polymers selected from the group consisting of polymers in the polysulfone family, more preferably selected from the group consisting of polysulfone (PSU) and polyphenylsulfone (PPSU), and most preferably polyphenylsulfone meet the unique criteria set forth above and result in an improved product compared to those currently used in industry.

A method of obtaining information regarding relative density from a sample containing materials such as, but not limited to, crude oil, petroleum products, petrochemicals, fractions thereof, and impurities therein is also disclosed herein. The method comprises the steps of (1) introducing the sample into a container, (2) lowering the hydrometer into the container until it floats freely, and (3) obtaining information regarding the relative density of the sample based on the graduated markings on the hydrometer, wherein the hydrometer is substantially chemically inert to degradation by crude oil and petroleum products, and substantially shatter-resistant. In some preferred embodiments, the hydrometer used is also substantially thermally stable and substantially rigid when subjected to conditions such as elevated temperatures.

### BRIEF DESCRIPTION OF THE DRAWINGS

FIG. 1 illustrates an embodiment of the centrifuge tube disclosed herein.

### DETAILED DESCRIPTION OF THE ILLUSTRATED EMBODIMENTS

The use of polymeric materials as glass substitutes to make products suitable for use in the analysis of liquid samples and the corresponding products are disclosed herein. Polymer-based products suitable for use in the analysis of liquid samples may be particularly useful in petroleum industry applications, though the use of such products is not limited to the petroleum industry. It has been found making products from one or more polymers selected from the group consisting of polymers in the polysulfone family, more preferably selected from the group consisting of polysulfone (PSU) and polyphenylsulfone (PPSU), and most preferably polyphenylsulfone may render the products substantially transparent; substantially chemically inert to degradation by crude oil and petroleum products; substantially thermally stable; substantially rigid when subjected to conditions such as elevated temperatures, externally-applied forces, or the combination thereof; and substantially shatter-resistant and will result in products with superior performance as compared to products currently used in industrial applications.

In one embodiment, a container that may be used to measure sediment and water content and other properties of samples comprising, crude oil, petroleum products, petrochemicals, fractions thereof, and impurities therein is disclosed. The disclosed container comprises one or more polymers that render the container substantially transparent; substantially chemically inert to degradation by crude oil and petroleum products; substantially thermally stable; substantially rigid when subjected to conditions such as elevated temperatures, centrifugal, threes, or the combination thereof; and substantially shatter-resistant.

The preferred container is a solid, rigid receptacle with at least one closed end and one open end, and is capable of containing a sample such as a liquid, liquid-solids mixture, or another sample capable of being separated or otherwise partitioned by centrifugal forces. The open end of the container may be configured to be securely closed using a cap such as a threaded screw cap, a stopper such as a rubber stopper or a stopper made from another suitable material, or other seal. The container preferably comprises a tube with one closed end and one open end, although the container does not need to be tubular and can be configured in other cross-sectional shapes as may be suitable for use in various applications. The container, whether a tube or another configuration, may be the same diameter across its entire length or may include differing cross-sectional diameters or other dimensions. Preferably, the container comprises a centrifuge tube, wherein the centrifuge tube may have an approximately uniform diameter across its entire length or may have an approximately uniform diameter across a part of its length and terminate with a conical tip at the end of the tube opposing the open end. A centrifuge tube that has an approximately uniform diameter across a part of its length and terminates with a conical tip at the end of the tube opposing the open end may be particularly suitable to receive more dense materials or precipitate separated during centrifugation.

It has been found that centrifuge tubes suitable for use with materials used in the petroleum industry for sediment and water measurement applications and other property measurements will fail or undoubtedly be less effective unless they are substantially: (1) transparent; (2) chemically inert to degradation by crude oil and petroleum products; (3) thermally stable; (4) rigid when subjected to conditions such as elevated temperatures, centrifugal herein, or the combination thereof; and (5) shatter-resistant; as those terms are defined herein. Preferably, at least two of these properties will be satisfied in conjunction with one another. More preferably, at least three of these properties will be satisfied in conjunction with one another. Even more preferably, at least four of these properties will be satisfied in conjunction with one another. Most preferably, all five of these properties will be satisfied in conjunction with the remaining properties. Thus, in the most preferred embodiments, a centrifuge tube will remain substantially transparent, substantially chemically inert to degradation, substantially stable, substantially rigid, and substantially shatter-resistant, particularly when exposed to crude oil, petroleum products, petrochemicals, fractions thereof, and/or impurities therein at elevated temperatures and centrifugal forces simultaneously.

The disclosed centrifuge tube is substantially transparent so that the amount of sediment and water in a sample may be determined visually or using another suitable technique for optical measurement after centrifugation. In some embodiments, centrifugation may cause a sample to substantially separate into a precipitate and a supernatant liquid within the centrifuge tube. In other embodiments, no precipitate will be present. As used herein, the term supernatant liquid refers to any liquid in the centrifuge tube after centrifugation, regardless of whether a precipitate is also present. In some embodiments, the supernatant liquid comprises at least two immiscible liquids, and the supernatant liquid is substantially separated into layers of immiscible liquids. In other embodiments, the supernatant liquid forms an emulsion or is otherwise not separated into multiple layers. A substantially transparent centrifuge tube will allow visual determination of the location of the interface between the precipitate and the supernatant liquid when a precipitate is present or allow visual determination of the interface between immiscible layers of liquids within the supernatant liquid if any such layers are present.

The centrifuge tube may also be labeled with volumetric graduations on its exterior surface. Since the disclosed centrifuge tube is substantially transparent, a user can visually observe and measure the sediment and water in a sample using the volumetric graduations on the exterior of the centrifuge tube.

When determining the amount of sediment and water in crude oil, petroleum products, petrochemicals, fractions thereof, and impurities therein, after centrifugation a sample will generally separate into a precipitate comprising sediment and a supernatant liquid comprising a water layer and a hydrocarbon layer that is immiscible with and less dense than the water layer. After centrifugation, the precipitate will be located at the bottom of the centrifuge and the hydrocarbon layer will be located above the water layer within the supernatant liquid, on account of the lower density of the hydrocarbon layer. Use of a substantially transparent centrifuge tube will allow visual determination of the interface between the water layer and the precipitate and will also allow visual determination of the interface between the water layer and the hydrocarbon layer. Thus the amount of sediment and water in a sample may be visually determined and may be quantified using volumetric graduations of the centrifuge tube if present. It is also understood that, in certain circumstances, the supernatant liquid comprising one or more hydrocarbons and water may not fully partition and there may thus be no visually distinguishable interface between a hydrocarbon layer and a water layer within the supernatant liquid.

The centrifuge tube may preferably be sufficiently transparent so as to have a transmittance above 50 percent, more preferably a transmittance above 65 percent, and most preferably a transmittance above 80 percent.

The disclosed centrifuge tube is substantially chemically inert to degradation by crude oil and petroleum products, including crude oil, kerosene, mineral spirits, Stoddard solvent, Varsol, and other petroleum products, petrochemicals, fractions thereof, and impurities therein. Chemical degradation of the centrifuge tube may lead to reduced mechanical strength that may result in mechanical failure, may lead to possible contamination of samples by byproducts of chemical degradation processes, and may also lead to other potentially deleterious consequences. In preferred embodiments, the centrifuge tube is substantially chemically inert to degradation by a test solvent where the testing is carried out according to the test conditions set forth in Woishnis, et al. Chemical Resistance of Specialty Thermoplastics, 2012, Elsevier Inc., 876-903 (hereinafter “Woishnis, et al.”).

Chemical degradation of a centrifuge tube comprising one or more polymers may be caused by disruption of the order of individual polymer chains that is introduced during the manufacture of the centrifuge tube by increasing the stress on the individual polymer chains. When the stress passes a given limit, evidence of chemical degradation may be observed visually. Visual indications of chemical degradation include but are not limited to crazing, hazing, cloudiness, and discoloration.

Crude oil and other petroleum products may sometimes contain sufficiently high percentages of solids and other materials, such as paraffinic waxes, asphaltenes, and other substances that can solidify or become sufficiently viscous at room temperature so as to impede or disrupt the formation of layers during the centrifuging step. For this and other reasons, these samples may be heated prior to or during the centrifuging step so as to help ensure that sample separation can take place in the centrifuge.

The disclosed centrifuge tube is substantially thermally stable, so that it does not appreciably expand or contract or otherwise physically deform when processing samples that must be heated for proper analysis. Any expansion or contraction of less than 100 μm/m-° C. will not be considered appreciable. Accurate volumetric measurements, such as sediment and water measurements for crude oil samples or other volumetric measurements related to the separation of liquids from solids or other liquids in samples such as crude oil, petroleum products, petrochemicals, fractions thereof, and impurities therein, require minimal thermal expansion. If a centrifuge tube exhibits appreciable thermal expansion, there may be discrepancies in volumetric measurements of the contents of the centrifuge tube at different temperatures. Therefore, in preferred embodiments, the centrifuge tube comprises one or more polymers with a coefficient of thermal expansion that is less that 100 μm/m-° C. at both 25 degrees Celcius and 70 degrees Celcius, more preferably a coefficient of thermal expansion that is less than 85 μm/m-° C. at both 25 degrees Celcius and 70 degrees Celcius, even more preferably a coefficient of thermal expansion that is less than 70 μm/m-° C. at both 25 degrees Celcius and 70 degrees Celcius, and most preferably a coefficient of thermal expansion that is less than 50 μm/m-° C. at both 25 degrees Celcius and 70 degrees Celcius for best results.

In addition, the disclosed centrifuge tube is substantially rigid when exposed to elevated temperatures, such that the tube does not deform when exposed to elevated temperatures and thereby introduce unacceptable measurement errors into sediment and water measurements, or into other measurements related to the separation of liquids from solids or other liquids in samples such as crude oil, petroleum products, petrochemicals, fractions thereof, and impurities therein. When the glass transition temperature of a polymeric material is exceeded, the material may lose its mechanical rigidity and may deform when exposed to forces such as centrifugal forces. For materials that do not have a defined glass transition temperature, measurement of mechanical strength may be an alternative way of measuring rigidity that correlates directly to the preferred ranges for glass transition temperatures. In preferred embodiments, the centrifuge tube comprises one or more polymers with a glass transition temperature above approximately 70 degrees Celcius, more preferably above approximately 120 degrees Celcius, even more preferably above approximately 160 degrees Celcius, and most preferably above approximately 210 degrees Celcius for best results.

In addition to the effect of exceeding the glass transition temperature on the rigidity of a centrifuge tube comprising polymeric materials, the amount of force exerted upon the centrifuge tube also may affect its rigidity. The disclosed centrifuge tube is substantially rigid when exposed to centrifugal forces, such that the tube does not deform during centrifugation and thereby introduce unacceptable measurement errors into sediment and water measurements, or into other measurements related to the separation of liquids from solids or other liquids in samples such as crude oil, petroleum products, petrochemicals, fractions thereof, and impurities therein. In preferred embodiments, the centrifuge tube is substantially rigid when exposed to a relative centrifugal force (RCF) of 500, more preferably an RCF of 750, even more preferably an RCF of 900, and most preferably an RCF of 1000 for best results.

The disclosed centrifuge tube is substantially shatter-resistant to prevent breakage or other damage during handling and use. If a centrifuge tube breaks or is damaged during handling or use, one or more deleterious consequences may result, including but not limited to sample contamination, safety concerns for the centrifuge operator and others, and increased costs of testing. The centrifuge tube is preferably shatter-resistant when dropped from a height of 1 m onto a concrete surface comprising Portland cement, more preferably shatter-resistant when dropped from a height of 3 m onto a concrete surface comprising Portland cement, even more preferably shatter-resistant when dropped from a height of 5 m onto a concrete surface comprising Portland cement, and most preferably shatter-resistant when dropped from a height of 8 m onto a concrete surface comprising Portland cement for best results.

The disclosed container comprises one or more polymers that generally meet the unique criteria defined above. Preferably, the one or more polymers have at least one member selected from the group consisting of polymers in the polysulfone family. The polysulfone family comprises thermoplastic polymers comprising at least one monomer comprising a sulfone moiety, including polysulfone (PSU), polyethersulfone (PESU), and polyphenylsulfone (PPSU). More preferably, the one or more polymers have at least one member selected from the group consisting of polysulfone (PSU) and polyphenylsulfone (PPSU). Even more preferably, the one or more polymers comprise polyphenylsulfone (PPSU) for best results.

It has been found that polyphenylsulfone (PPSU) may be more chemically inert to certain test samples, such as test samples containing higher percentages of aromatics with 25 or fewer carbon atoms per molecule, such as benzene, toluene, and xylene. Polyphenylsulfone (PPSU) is particularly preferred over other members of the polysulfone family where a test sample comprises more than 10 volume percent aromatic hydrocarbons with 25 or fewer carbon atoms per molecule, more preferred where a test sample comprises more than 15 volume percent aromatic hydrocarbons with 25 or fewer carbon atoms per molecule, and particularly preferred where a test sample comprises more than 20 volume percent aromatic hydrocarbons with 25 or fewer carbon atoms per molecule.

In some embodiments, the centrifuge tube may comprise a polysulfone copolymer or a polyphenylsulfone copolymer.

In other embodiments, the one or more polymers in the polysulfone family may be impregnated with glass fibers.

A method of obtaining information from a sample containing materials such as, but not limited to, crude oil, petroleum products, petrochemicals, fractions thereof, and impurities therein is also disclosed herein. The method comprises the steps of (1) introducing the sample into a container, (2) applying a force to the container to generate at least two layers within the container, and (3) obtaining information from at least one of the at least two layers, wherein the container is substantially transparent; substantially chemically inert to degradation by crude oil and petroleum products; substantially thermally stable; substantially rigid when subjected to conditions such as elevated temperatures, centrifugal forces, or the combination thereof; and substantially shatter-resistant.

The container is the apparatus for partially, substantially, or fully enclosing the sample to which force will be applied. The container may preferably be enclosed in a protective sleeve to prevent scratching or other damage caused by contact between the container and the instrument used to apply force to the container. When the container is a centrifuge tube subjected to a force using a centrifuge, the protective sleeve may prevent scratching or other damage caused by contact between the centrifuge tube and the metal surface of the centrifuge tube holder or pre-heating element. The protective sleeve may preferably be made from nylon such as an anti-static nylon. The protective sleeve may be configured to securely contain a desired centrifuge tube. The protective sleeve may further include a double-sided adhesive on its exterior surface to allow the protective sleeve to be secured to the metal surface of the centrifuge tube holder or pre-heating clement.

The present disclosure contemplates measuring samples that may include crude oil, petroleum products, petrochemicals, syncrude, tar sands, shale oil, solids, water, naphthenic and other associated acids, fractions thereof, and impurities therein. The feedstock may be heterogeneous or homogenous. The chemical composition of a sample may include, but is not limited to, paraffins, naphthenes, aromatics, sulfur-containing structures, nitrogen-containing structures, asphaltenes, and the like generally found in petroleum crude, petroleum products, petrochemicals, fractions thereof, and impurities therein. In some embodiments, the sample may comprise up to 0.2 volume percent aromatic hydrocarbons with 25 or fewer carbon atoms per molecule. In other embodiments, the sample may comprise as much as 0.6, 1.0, or 2.0 volume percent aromatic hydrocarbons with 25 or fewer carbon atoms per molecule. In less common embodiments, the sample may comprise as much as 5, 10, or 20 volume percent aromatic hydrocarbons with 25 or fewer carbon atoms per molecule.

The force that is applied is generally centripetal force applied via a centrifuge but may alternatively comprise other forces applied to separate composite materials by their relative densities.

The method generally separates the sample into at least two layers. One layer is generally a precipitate while at least one other layer is generally a supernatant liquid comprising one or more hydrocarbons. The precipitate often comprises one or more sediments. In some embodiments, no precipitate is present. The supernatant liquid may comprise discrete water and hydrocarbon layers that may be substantially immiscible with one another or the water and hydrocarbon layers may not partition and may exist as a single layer. The water layer may be water or may alternatively be an aqueous solution of water soluble compounds in water, with or without water insoluble compounds suspended therein. In some embodiments, the water layer may be an emulsion of water insoluble compounds suspended in water or an aqueous solution.

A method of making the disclosed container is also disclosed herein. The method comprises: (1) heating at least one polymer selected from the group consisting of the polysulfone family, (2) extruding the heated polymer to generate an extruded polymer, (3) introducing the extruded polymer into a mold having the shape of the container, and (4) removing the mold from the extruded polymer contained within the mold to generate a polymer container, wherein the polymer container is substantially transparent; substantially chemically inert to degradation by crude oil and petroleum products; substantially thermally stable; substantially rigid when subjected to conditions such as elevated temperatures, centrifugal forces, or the combination thereof; and substantially shatter-resistant.

The container may be made using an injection molding process such as the injection molding process for making a centrifuge tube described below. For example, polyphenylsulfone pellets may be dried according to drying parameters in a pre-processing step to remove any trace water in the pellets. The drying parameters may be any suitable temperature and drying time for removing trace water. The drying parameters may preferably be a temperature between approximately 250 and 400 degrees Fahrenheit, more preferably approximately 300 degrees Fahrenheit, and a drying time of between approximately 3 and 5 hours, more preferably approximately 4 hours. The pellets may then be placed in an injection molding apparatus comprising an extruder and a mold. The pellets may be melted by the extruder and then fed into the mold at high temperature and pressure. The melted polymer may be injected into the mold during an injection period, wherein the injection period may preferably be between approximately 3 and 8 seconds and more preferably be approximately 5.5 seconds. The mold may be held for a setting period, wherein the setting period may preferably be between approximately 20 and 30 seconds and more preferably be approximately 25 seconds.

By way of example, the centrifuge tube may be made using an injection molding apparatus, wherein the injection molding apparatus may be operated according to the parameters shown in Table 1.

TABLE 1

| Temperature at Nozzle | 710° | F. |
|---|---|---|
| Temperature at Middle 1 | 720° | F. |
| Temperature at Middle 2 | 720° | F. |
| Temperature at Rear | 700° | F. |
| Temperature at Mold A | 275° | F. |
| Temperature at Mold B | 275° | F. |
| Maximum injection pressure | 22300 | psi |
| Maximum injection time | 5.5 | s |
| Maximum pack | 0.50 | IPS |
| Extruder pressure | 1000 | psi |
| Extruder RPM | 50 | |
| Shot size | 2.000 | oz |
| Cooling time | 25.0 | s |

The polyphenylsulfone pellets used in the above example were obtained from Dongguan Jiate Plastics Co., Ltd. (JT-PPSU-5000).

Alternatively, by way of example, the centrifuge tube may be made in a two-step process using an injection molding apparatus and an ultrasonic welding apparatus, where two parts of the centrifuge tube are separately injection molded and then the two injection molded parts are subsequently welded together using an ultrasonic welding process to form the centrifuge tube. The injection molding apparatus may be operated according to the parameters shown in Table 2, and the ultrasonic welding apparatus may be operated according to the parameters shown in Table 3.

TABLE 2

| | | |
|---|---|---|
| Pressure | 80-160 | mPa |
| Mold Temperature | 180 | ° C. |
| Injection Temperature | 360-370 | ° C. |

| | |
|---|---|
| Mold Material | P20 steel |

TABLE 3

| | | |
|---|---|---|
| Frequency | 1500 | kHz |
| Amplitude | 30 | μm |
| Electrical Current | 1.8 | A |
| Delay | 0.7 | s |
| Dissolution Time | 8 | s |
| Cooling Time | 0.6 | s |

The parameters specified above to make centrifuge tubes using an injection molding process and an optional ultrasonic welding process are merely illustrative, and one or more parameters may be varied without departing from the scope and spirit of the disclosed method.

In some preferred embodiments, the centrifuge tube may be coated with one or more coatings. The one or more coatings may preferably be applied as spray coatings. In some highly preferred embodiments, the one or more coatings may be one or more coatings selected from the group consisting of a polyurethane coating and a spar urethane coating, and even more preferably a spar urethane coating. In some preferred embodiments, two spray coatings may be applied to the centrifuge tubes. The two spray coatings may be applied with a time delay between application of each coating, and the two spray coatings may be the same or different.

For example, a spar urethane coating manufactured by Varathane was applied to centrifuge tubes as two spray coatings. The time delay between application of the two coatings was 1 h, and the coatings were cured at room temperature for 24 h. The coated centrifuge tubes were visually unaffected when heated to 200 degrees Fahrenheit for 12 h or when submerged in Varsol for 24 h.

In some preferred embodiments, an optical finish may be applied to the mold used to make the injection molded centrifuge tube to increase transparency of the tube. The Society of Plastic Industry (SPI) defines optical finishes according to the type of finish, including diamond buff polish to generate a glossy surface, paper polish to generate a non-glossy surface, stone polish to generate a rough surface, and dry blash polish to generate a very rough surface. The SPI diamond buff polishes include SPI Finish A-1 (Grade #3, 6000 Grit Diamond Buff), SPI Finish A-2 (Grade #6, 3000 Grit Diamond Buff), and SPI Finish A-3 (Grade #15, 1200 Grit Diamond Buff). The optical finish may preferably be applied to the mold using one or more polishing steps to apply a finish selected from the group consisting of SPI Finish A-1, SPI Finish A-2, and SPI Finish A-3, more preferably applied using one or more polishing steps to apply an SPI Finish A-2.

The container may alternatively be made using an injection blow molding or extrusion blow molding process. In some embodiments, an optical finish may be applied to the mold used to make the container as described above and according to the preferred parameters described above. In some embodiments, one or more spray coatings may be applied to the container as described above and according to the preferred parameters described above.

Centrifuge tubes comprising polyphenylsulfone (PPSU) and made using the injection molding process described in the above example were tested for thermal stability when exposed to petroleum products. Centrifuge tubes were exposed to kerosene and Varsol to determine whether any changes would be observed in the overall length of the tubes or for volumetric measurement of individual graduations on the tubes. The height of the empty centrifuge tubes were measured prior to exposure to any petroleum products. The volumes corresponding to each graduation on each centrifuge tube were then verified using verification procedures set forth by the American Petroleum Institute. See American Petroleum Institute, Manual of Petroleum Measurement Standards, 2013, ch. 10, section 4 (hereinafter “API Chapter 10.4”). Each centrifuge tube was then filled with kerosene or Varsol and pre-heated to 200 degrees Fahrenheit. The tubes were centrifuged at 200 degrees Fahrenheit for 2 hours at a maximum RPM corresponding to a relative centrifugal force (RCF) of approximately 1000. These conditions are significantly more rigorous than those required by API Chapter 10.4. The kerosene or Varsol was then removed from the centrifuge tubes, and the centrifuge tubes were subsequently cleaned. The volumes corresponding to each graduation on each centrifuge tube were then reverified using verification procedures set forth in API Chapter 10.4, and the heights of the empty centrifuge tubes were remeasured. As shown in Table 4, the tube heights before and after centrifugation were consistent within 0.015%, which was within the measurement error.

TABLE 4

| | Kerosene | Kerosene | Varsol | Varsol |
|---|---|---|---|---|
| | Tube | Tube | Tube | Tube |
| | Pre-Cen- | Post-Cen- | Pre-Cen- | Post-Cen- |
| | trifugation | trifugation | trifugation | trifugation |
| Measured | 133.39 | 133.45 | 133.44 | 133.44 |
| Height (mm) | | | | |
| Measured | 133.38 | 133.43 | 133.41 | 133.46 |
| Height (mm) | | | | |
| Measured | 133.42 | 133.43 | 133.42 | 133.43 |
| Height (mm) | | | | |
| Measured | 133.44 | 133.43 | 133.43 | 133.45 |
| Height (mm) | | | | |
| Measured | 133.40 | 133.43 | 133.42 | 133.42 |
| Height (mm) | | | | |
| Average | 133.41 | 133.43 | 133.42 | 133.44 |
| Height (mm) | | | | |

As shown in Table 5, the volumetric verifications for each graduation were well within allowable tolerances.

TABLE 5

| | | Kerosene | | Varsol | |
|---|---|---|---|---|---|
| | | Pre-Cen- | Post-Cen- | Pre-Cen- | Post-Cen- |
| Gradu- | Toler- | trifugation | trifugation | trifugation | trifugation |
| ation | ance | Measured | Measured | Measured | Measured |
| (mL) | (+/−) | Tolerance | Tolerance | Tolerance | Tolerance |
| 0.05 | 0.02 | 0.000 | 0.001 | 0.002 | 0.001 |
| 0.10 | 0.02 | 0.005 | 0.005 | 0.002 | 0.000 |
| 0.15 | 0.03 | 0.020 | 0.001 | 0.005 | 0.000 |
| 0.20 | 0.03 | 0.019 | 0.004 | 0.007 | 0.003 |
| 0.25 | 0.03 | 0.027 | 0.001 | 0.004 | 0.008 |
| 0.30 | 0.03 | 0.014 | 0.001 | 0.013 | 0.010 |
| 0.35 | 0.05 | 0.029 | 0.005 | 0.013 | 0.002 |
| 0.40 | 0.05 | 0.020 | 0.012 | 0.012 | 0.019 |
| 0.45 | 0.05 | 0.021 | 0.012 | 0.013 | 0.017 |
| 0.50 | 0.05 | 0.027 | 0.012 | 0.014 | 0.017 |
| 1.0 | 0.1 | 0.032 | 0.016 | 0.043 | 0.015 |
| 1.5 | 0.1 | 0.042 | 0.018 | 0.088 | 0.019 |
| 2.0 | 0.3 | 0.051 | 0.024 | 0.096 | 0.022 |
| 50 | 1.5 | 0.534 | 0.397 | 1.314 | 0.212 |
| 100 | 1.5 | 0.114 | 0.099 | 0.837 | 0.031 |

Centrifuge tubes were also subjected to repeated exposure to kerosene or Varsol to measure thermal stability after repeated use. The height of an empty centrifuge tube was measured prior to exposure to any petroleum products. The centrifuge tube was then filled with kerosene or Varsol. The tube was then centrifuged at 160 degrees Fahrenheit for 5 minutes at a maximum RPM corresponding to a relative centrifugal force (RCF) of approximately 1000. The height of the tube was then remeasured after centrifugation. This process was repeated 100 times. After 100 iterations using both kerosene and Varsol, the heights of the centrifuge tubes did not change appreciably and the tubes were transparent without any indication of chemical degradation.

Centrifuge tubes made from polymers in the polysulfone family were compared for chemical inertness. Centrifuge tubes were made from polyphenylsulfone (PPSU) as described above. Centrifuge tubes were also made from polysulfone (PSU) using the same injection molding procedures described above. Each PPSU centrifuge tube and PSU centrifuge tube was filled with a test solvent and heated to 150 degrees Fahrenheit. The centrifuge tubes were heated continuously until visual indications of chemical degradation appeared, such as crazing, hazing, cloudiness, or discoloration. Where no visual indication of chemical degradation was observed after one week, the centrifuge tubes were deemed chemically inert. under the test conditions. The test solvents used were a mixture of aliphatic and aromatic hydrocarbons, or alternatively exclusively aromatic hydrocarbons. In particular, the test solvents were a mixture of xylenes and kerosene or pure xylenes. The test results are shown in Table 6.

TABLE 6

| [xylenes] in | PSU tube | PPSU tube |
|---|---|---|
| test solvent | degradation time | degradation time |
| (% v) | (min) | (min) |
| 10 | Inert | Inert |
| 20 | 240 | Inert |
| 30 | 120 | Inert |
| 80 | 8 | Inert |
| 90 | 4 | Inert |
| 100 | 2 | Inert |

As shown in Table 4, PPSU centrifuge tubes are significantly more chemically inert to xylenes than PSU centrifuge tubes. These results suggest that PSU centrifuge tubes are likely significantly less chemically resistant to high concentrations of aromatic hydrocarbons and thus are less suitable for use in testing of crude oil or petroleum product samples that include a high percentage of aromatic hydrocarbons.

Centrifuge tubes made using the using the injection molding process described in the above example were tested for shatter resistance using a gravity drop procedure. Glass centrifuge tubes were used as a reference. 100 mL centrifuge tubes were filled with water. Polymer centrifuge tubes were closed with a threaded screw cap, and glass centrifuge tubes were closed with a rubber stopper. The centrifuge tubes were dropped from a pre-defined height, defined as the distance between the bottom of the centrifuge tube and the impact surface, onto a concrete surface comprising Portland cement. Both glass centrifuge tubes and polymer centrifuge tubes were undamaged when dropped from a height of 0.3 m. Glass centrifuge tubes were damaged, as indicated by cracking, chipping, or shattering, when dropped from all heights from between 0.6 m and 9.1 m, whereas polymer centrifuge tubes were undamaged when dropped from all heights below at least 9.1 m. The gravity drop tests were carried out at thirty different heights between about 0.3 m and 9.1 m.

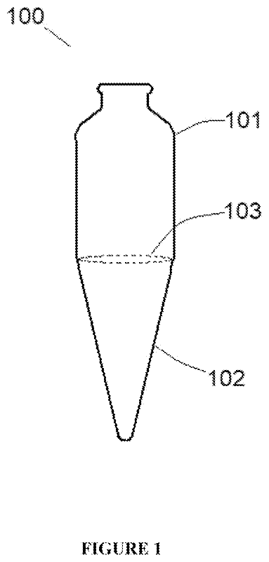

FIG. 1 shows an embodiment 100 of the disclosed centrifuge tube made using a two-step process. Parts 101 and 102 of the centrifuge tube 100 are separately injection molded and are then welded together at interface 103 using an ultrasonic welding apparatus.

In another embodiment, a hydrometer suitable for obtaining information from a sample containing materials such as, but not limited to, crude oil, petroleum products, petrochemicals, fractions thereof, and impurities therein is described. A hydrometer comprising one or more polymers that render the hydrometer substantially chemically inert to degradation by crude oil and petroleum products and substantially shatter-resistant provides superior performance for measurement of API gravity or other measurements of relative density of a sample for crude oil and petroleum products compared to hydrometers that do not satisfy these criteria. In some preferred embodiments, the hydrometer is also substantially thermally stable. In some preferred embodiments, the hydrometer is also substantially rigid when subjected to conditions such as elevated temperatures. In some preferred embodiments, the hydrometer is substantially thermally stable and substantially rigid when subjected to conditions such as elevated temperatures. In some embodiments, the hydrometer is also substantially transparent. Hydrometers made from one or more polymers selected from the group consisting of polymers in the polysulfone family, more preferably selected from the group consisting of polysulfone (PSU) and polyphenylsulfone (PPSU), and most preferably polyphenylsulfone meet the unique criteria set forth above and result in an improved product compared to those currently used in industry.

Hydrometers suitable for use with materials used in the petroleum industry for the measurement of the relative density of such materials will provide superior performance if they are substantially: (1) chemically inert to degradation by crude oil and petroleum products, (2) shatter-resistant, as those terms are defined herein. In some preferred embodiments, the hydrometer is also substantially thermally stable, as defined herein. In some preferred embodiments, the hydrometer is also substantially rigid when subjected to conditions such as elevated temperatures, as defined herein. In some preferred embodiments, the hydrometer is substantially thermally stable and substantially rigid when subjected to conditions such as elevated temperatures. In some embodiments, the hydrometer is also substantially transparent, as defined herein. Most preferably, all five of these properties will be satisfied in conjunction with the remaining properties. Thus, in the most preferred embodiments, a hydrometer will remain substantially transparent, substantially chemically inert to degradation, substantially stable, substantially rigid, and substantially shatter-resistant, particularly when exposed to crude oil, petroleum products, petrochemicals, fractions thereof, and/or impurities therein at elevated temperatures.

The disclosed hydrometer is substantially shatter-resistant to prevent breakage or other damage during handling and use. If a hydrometer breaks or is damaged during handling or use, one or more deleterious consequences may result, including but not limited to sample contamination, safety concerns for the operator and others, and increased costs of testing. The hydrometer is preferably shatter-resistant when dropped from a height of 1 m onto a concrete surface comprising Portland cement, more preferably shatter-resistant when dropped from a height of 3 m onto a concrete surface comprising Portland cement, even more preferably shatter-resistant when dropped from a height of 5 m onto a concrete surface comprising Portland cement, and most preferably shatter-resistant when dropped from a height of 8 m onto a concrete surface comprising Portland cement for best results.

The disclosed hydrometer is substantially chemically inert to degradation by crude oil and petroleum products, including crude oil, kerosene, mineral spirits, Stoddard solvent, Varsol, and other petroleum products, petrochemicals, fractions thereof, and impurities therein. Chemical degradation of the hydrometer may lead to reduced mechanical strength that may result in mechanical failure, may lead to possible contamination of samples by byproducts of chemical degradation processes, and may also lead to other potentially deleterious consequences. In preferred embodiments, the hydrometer is substantially chemically inert to degradation by a test solvent where the testing is carried out according to the test conditions set forth in Woishnis, et al.

Chemical degradation of a hydrometer comprising one or more polymers may be caused by disruption of the order of individual polymer chains that is introduced during the manufacture of the hydrometer by increasing the stress on the individual polymer chains. When the stress passes a given limit, evidence of chemical degradation may be observed visually. Visual indications of chemical degradation include but are not limited to crazing, hazing, cloudiness, and discoloration.

Crude oil and other petroleum products may sometimes contain sufficiently high percentages of solids and other materials, such as paraffinic waxes, asphaltenes, and other substances that can solidify or become sufficiently viscous at room temperature so as to impede or disrupt the free floating of a hydrometer placed therein. For this and other reasons, these samples may be heated prior to placement of a hydrometer therein so as to help ensure that the hydrometer may float freely within the sample.

The hydrometer may preferably be substantially transparent. If the hydrometer is substantially transparent, visual indicators of chemical degradation may be readily observed. In some applications, substantial transparency of the hydrometer will also facilitate the visual determination of the relative density of a sample by determining the location of the interface between the hydrometer and the sample when the hydrometer is placed in a container containing the sample.

The hydrometer may preferably be sufficiently transparent so as to have a transmittance above 50 percent, more preferably a transmittance above 65 percent, and most preferably a transmittance above 80 percent.

The hydrometer may preferably be substantially thermally stable, so that it does not appreciably expand or contract or otherwise physically deform when processing samples that must be heated for proper analysis. Any expansion or contraction of less than 100 μm/m-° C. will not be considered appreciable. Accurate measurements in samples such as crude oil, petroleum products, petrochemicals, fractions thereof, and impurities therein, require minimal thermal expansion. If a hydrometer exhibits appreciable thermal expansion, there may be discrepancies in measurements of relative density at different temperatures. Therefore, in preferred embodiments, the hydrometer comprises one or more polymers with a coefficient of thermal expansion that is less than 100 μm/m-° C. at both 25 degrees Celcius and 70 degrees Celcius, more preferably a coefficient of thermal expansion that is less than 85 μm/m-° C. at both 25 degrees Celcius and 70 degrees Celcius, even more preferably a coefficient of thermal expansion that is less than 70 μm/m-° C. at both 25 degrees Celcius and 70 degrees Celcius, and most preferably a coefficient of thermal expansion that is less than 50 μm/m-° C. at both 25 degrees Celcius and 70 degrees Celcius for best results.

In addition, the hydrometer may preferably be substantially rigid when exposed to elevated temperatures, such that the hydrometer does not deform when exposed to elevated temperatures and thereby introduce unacceptable measurement errors into relative density measurements in samples such as crude oil, petroleum products, petrochemicals, fractions thereof, and impurities therein. When the glass transition temperature of a polymeric material is exceeded, the material may lose its mechanical rigidity and may deform when exposed to externally-applied forces. For materials that do not have a defined glass transition temperature, measurement of mechanical strength may be an alternative way of measuring rigidity that correlates directly to the preferred ranges for glass transition temperatures. In preferred embodiments, the hydrometer comprises one or more polymers with a glass transition temperature above approximately 70 degrees Celcius, more preferably above approximately 120 degrees Celcius, even more preferably above approximately 160 degrees Celcius, and most preferably above approximately 210 degrees Celcius for best results.

The disclosed container comprises one or more polymers that generally meet the unique criteria defined above. Preferably, the one or more polymers have at least one member selected from the group consisting of polymers in the polysulfone family. More preferably, the one or more polymers have at least one member selected from the group consisting of polysulfone (PSU) and polyphenylsulfone (PPSU). Even more preferably, the one or more polymers comprise polyphenylsulfone (PPSU) for best results.

Polyphenylsulfone (PPSU) may be more chemically inert to certain test samples, such as test samples containing higher percentages of aromatics with 25 or fewer carbon atoms per molecule, such as benzene, toluene, and xylene. Polyphenylsulfone (PPSU) is particularly preferred over other members of the polysulfone family where a test sample comprises more than 10 volume percent aromatic hydrocarbons with 25 or fewer carbon atoms per molecule, more preferred where a test sample comprises more than 15 volume percent aromatic hydrocarbons with 25 or fewer carbon atoms per molecule, and particularly preferred where a test sample comprises more than 20 volume percent aromatic hydrocarbons with 25 or fewer carbon atoms per molecule.

In some embodiments, the hydrometer may comprise a polysulfone copolymer or a polyphenylsulfone copolymer.

In other embodiments, the one or more polymers in the polysulfone family may be impregnated with glass fibers.

The disclosed hydrometer may be used to measure the relative density of samples that may include crude oil, petroleum products, petrochemicals, syncrude, tar sands, shale oil, solids, water, naphthenic and other associated acids, fractions thereof, and impurities therein. The feedstock may be heterogeneous or homogenous. The chemical composition of a sample may include, but is not limited to, paraffins, naphthenes, aromatics, sulfur-containing structures, nitrogen-containing structures, asphaltenes, and the like generally found in petroleum crude, petroleum products, petrochemicals, fractions thereof, and impurities therein. In some embodiments, the sample may comprise up to 0.2 volume percent aromatic hydrocarbons with 25 or fewer carbon atoms per molecule. In other embodiments, the sample may comprise as much as 0.6, 1.0, or 2.0 volume percent aromatic hydrocarbons with 25 or fewer carbon atoms per molecule. In less common embodiments, the sample may comprise as much as 5, 10, or 20 volume percent aromatic hydrocarbons with 25 or fewer carbon atoms per molecule.

A method of obtaining information regarding relative density from a sample containing materials such as, but not limited to, crude oil, petroleum products, petrochemicals, fractions thereof, and impurities therein is also disclosed herein. The method comprises the steps of (1) introducing the sample into a container, (2) introducing a hydrometer with graduated markings thereon into the container containing the sample until the hydrometer floats freely, and (3) obtaining information regarding the relative density of the sample based on the graduated markings on the hydrometer, wherein the hydrometer is substantially chemically inert to degradation by crude oil and petroleum products, and substantially shatter-resistant. In some preferred embodiments, the hydrometer used is also substantially thermally stable. In some preferred embodiments, the hydrometer used is also substantially rigid when subjected to conditions such as elevated temperatures. In some preferred embodiments, the hydrometer used is also substantially thermally stable and substantially rigid when subjected to conditions such as elevated temperatures. In some embodiments, the hydrometer used is also substantially transparent.

Both centrifuge tubes and hydrometers may be exposed to impact forces from accidentally being dropped or otherwise mishandled. However, while centrifuge tubes are also exposed to centrifugal forces during use, hydrometers are exposed to different externally-applied forces during use, such as the force of impact between the hydrometer and the sample container into which it is introduced for measurement. The force of impact between the hydrometer and the sample container may result in breakage during use.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

All references cited herein are expressly incorporated by reference.

What is claimed is:

1. A container comprising one or more polymers that is useful for obtaining information from a sample, wherein the container is:
a. substantially chemically inert to degradation by crude oil and petroleum products; and
b. substantially shatter-resistant.

2. The container of claim 1 wherein the container is:
a. substantially thermally stable; and
b. substantially rigid when subjected to conditions such as elevated temperatures.

3. The container of claim 2 wherein the container is substantially transparent.

4. The container of claim 2 wherein the container is a centrifuge tube, wherein the centrifuge tube is:
i. chemically inert for at least 120 minutes when exposed to a solution of 20 volume percent xylenes in kerosene at 150 degrees Fahrenheit, wherein chemical inertness is determined visually based on observable indications of chemical degradation;
ii. shatter-resistant when gravity dropped onto a concrete surface comprising Portland cement from a height of 1 meter.
iii. thermally stable with a coefficient of thermal expansion less than 100 μm/m-° C. at both 25 degrees Celcius and 70 degrees Celcius; and
iv. substantially rigid at 70 degrees Celcius.

5. The container of claim 2 wherein the container is a centrifuge tube, wherein the centrifuge tube is:
i. thermally stable with a coefficient of thermal expansion less than 85 μm/m-° C. at both 25 degrees Celcius and 70 degrees Celcius;
ii. substantially rigid at 120 degrees Celcius; and
iii. shatter-resistant when gravity dropped onto a concrete surface comprising Portland cement from a height of 3 meters.

6. The container of claim 2 wherein the container is a centrifuge tube, wherein the centrifuge tube is:
i. thermally stable with a coefficient of thermal expansion less than 70 μm/m-° C. at both 25 degrees Celcius and 70 degrees Celcius;
ii. substantially rigid at 160 degrees Celcius; and
iii. shatter-resistant when gravity dropped onto a concrete surface comprising Portland cement from a height of 5 meters.

7. The container of claim 2 wherein the container is a centrifuge tube, wherein the centrifuge tube is:
i. thermally stable with a coefficient of thermal expansion less than 50 μm/m-° C. at both 25 degrees Celcius and 70 degrees Celcius;
ii. substantially rigid at 210 degrees Celcius; and
iii. shatter-resistant when gravity dropped onto a concrete surface comprising Portland cement from a height of 7 meters.

8. The container of claim 1 wherein is a centrifuge tube and wherein the one or more polymers comprises at least one polymer from the polysulfone family.

9. The container of claim 9 wherein the one or more polymers comprises polyphenylsulfone.

10. The container of claim 7 wherein the one or more polymers comprises at least one polymer from the polysulfone family.

11. The container of claim 11 wherein the one or more polymers comprises polyphenylsulfone.

12. The container of claim 8 wherein the one or more polymers comprises at least one copolymer.

13. The container of claim 8 wherein at least one of the one or more polymers is impregnated with glass fibers.

14. A container comprising at least one polymer from the polysulfone family.

15. The container of claim 14 comprising polyphenylsulfone.

16. A method of obtaining information from a sample regarding the sediment and water content of the sample comprising the steps of:
a. introducing the sample into a container;
b. applying a force to the container to generate at least two layers within the container; and
c. obtaining information from at least one of the at least two layers;
wherein the container is substantially chemically inert to degradation by crude oil and petroleum products, and substantially shatter-resistant.

17. The method of claim 16 wherein the container is substantially thermally stable.

18. The method of claim 16 wherein the container is substantially rigid when subjected to conditions such as elevated temperatures.

19. The method of claim 17 wherein the container is substantially rigid when subjected to conditions such as elevated temperatures.

20. The method of claim 16 wherein the container comprises polyphenylsulfone.
